(19) United States
(12) Patent Application Publication
(10) Pub. No.: US 2025/0366650 A1
(43) Pub. Date: Dec. 4, 2025

(54) HEAT RETENTION COFFEE DRIPPER

(71) Applicant: Parker Roth, Naples, FL (US)

(72) Inventor: Parker Roth, Naples, FL (US)

(21) Appl. No.: 18/731,863

(22) Filed: Jun. 3, 2024

(51) Int. Cl. A47J 31/02; A47J 31/44

(52) U.S. Cl. CPC A47J 31/02; A47J 31/4403

(57) ABSTRACT

The Heat Retention Coffee Dripper enhances thermal efficiency in pour-over brewing by optimizing the venting passage from the beverage container along the filter and dripper walls. Configurations like spiral paths, multiple routes, and baffles lengthen the length of the venting passage and ensure efficient heat transfer and retention while maintaining optimal flow rates, preventing vacuum formation, and improving extraction and coffee quality.

### BACKGROUND

Coffee drippers have been utilized for many years, featuring various shapes and designs but consistently following the same principle: hot water is passed through coffee grounds into a beverage container below. These devices typically consist of a dripper body, filter, and base designed to sit on a beverage container. The brewing process involves placing the dripper on a beverage container, adding coffee grounds to a filter, pre-wetting the grounds, and then pouring hot water over them. The coffee drips through the filter and dripper into the beverage container below.

Traditional coffee drippers often face issues of significant heat loss or vacuum formation during the brewing process. Drippers with high flow rates tend to lose more heat quickly, reducing brewing temperatures and negatively impacting the extraction process and final coffee quality. Conversely, drippers that retain heat well often suffer from slower flow rates, leading to inefficiencies in brewing. There is a need for an improved coffee dripper design that balances heat retention and flow rate, thereby enhancing the overall brewing process and coffee quality.

### SUMMARY OF THE INVENTION

The Heat Retention Coffee Dripper is designed to enhance thermal efficiency in pour-over coffee brewing by optimizing the venting passage. This invention directs the vent passage from the beverage container up along the filter and dripper walls, extending the exposure time of heat within the system. Various configurations, including spiral paths, multiple routes, and strategically placed baffles, ensure efficient heat transfer and retention while maintaining optimal flow rates. This design prevents vacuum formation and improves the overall extraction process and coffee quality by ensuring that heat is effectively utilized and retained throughout the brewing process, achieving a balance between heat retention and flow rate.

### DESCRIPTION OF THE DRAWINGS

FIG. 1 is a perspective view of an embodiment of a heat retention coffee dripper, dripper body, filter, base, and beverage container.

FIG. 2 is an exploded perspective view of an embodiment of a heat retention coffee dripper, dripper body, filter, base, and beverage container.

FIG. 3 is a front elevation view of an embodiment of a dripper body for a heat retention coffee dripper.

FIG. 4 is a top plan view of an embodiment of a dripper body for a heat retention coffee dripper.

FIG. 5 is a bottom plan view of an embodiment of a dripper body for a heat retention coffee dripper.

FIG. 6 is a front cross-sectional view of an embodiment of a heat retention coffee dripper, dripper body, filter, base, and beverage container.

FIG. 7. is a front cross-sectional view of an embodiment of a dripper body for a heat retention coffee dripper.

FIG. 8. is a front cross-sectional view of an embodiment of a dripper body for a heat retention coffee dripper.

FIG. 9. is a front cross-sectional view of an embodiment of a dripper body for a heat retention coffee dripper.

FIG. 10. is a front cross-sectional view of an embodiment of a dripper body for a heat retention coffee dripper.

FIG. 11. is a front cross-sectional view of an embodiment of a of a dripper body for a heat retention coffee dripper.

FIG. 12. is a perspective view of an embodiment of a heat retention coffee dripper, dripper body, filter, base, and beverage container.

FIG. 13. is an exploded perspective view of an embodiment of a heat retention coffee dripper, dripper body, filter, base, and beverage container.

FIG. 14. is a front elevation view of an embodiment of a dripper body for a heat retention coffee dripper.

FIG. 15. is a top plan view of an embodiment of a dripper body for a heat retention coffee dripper.

FIG. 16. is a bottom plan view of an embodiment of a dripper body for a heat retention coffee dripper.

FIG. 17. is a front cross-sectional view of an embodiment of a heat retention coffee dripper, dripper body, filter, base, and beverage container.

FIG. 18. is a perspective view of an embodiment of a heat retention coffee dripper, dripper body, filter, base, and beverage container.

FIG. 19. is an exploded perspective view of an embodiment of a heat retention coffee dripper, dripper body, filter, base, and beverage container.

FIG. 20. is a front cross-sectional view of an embodiment of a heat retention coffee dripper, dripper body, filter, base, and beverage container.

FIG. 21. is a schematic view of flow directing structures.

FIG. 22. is a schematic view of flow directing structures.

FIG. 23. is a schematic view of flow directing structures.

FIG. 24. is a schematic view of flow directing structures.

FIG. 25. is a schematic view of flow directing structures.

FIG. 26. is a schematic view of flow directing structures.

FIG. 27. is a schematic view of flow directing structures.

FIG. 28. is a schematic view of flow directing structures.

FIG. 29. is a schematic view of flow directing structures.

FIG. 30. is a schematic view of flow directing structures.

FIG. 31. is a schematic view of flow directing structures.

FIG. 32. is a schematic view of flow directing structures.

FIG. 33. is a schematic view of flow directing structures.

FIG. 34. is a schematic view of flow directing structures.

FIG. 35. is a schematic view of flow directing structures.

FIG. 36. is a schematic view of flow directing structures.

FIG. 37. is a schematic view of flow directing structures.

FIG. 38. is a schematic view of flow directing structures.

### DETAILED DESCRIPTION

A few of the preferred embodiments have been illustrated and described in detail. It is understood, however, that numerous modifications can be made without departing from the invention's scope as claimed. Although these embodiments specifically discuss coffee, the invention is applicable to any infusible substance with at least one infusible liquid. Those skilled in the art will recognize that many variations and substitutions may be made, qualifying as equivalents under the patent claims. The specific embodiments described herein are intended only to exemplify the invention and should not be seen as limiting its spirit or scope.

In the figures, not every element is assigned a reference number. Directional terms such as “font,” “rear,” “upper,” “lower,” “bottom,” “top,” and “side” are used to describe the orientation of the components as depicted in the drawings. Those skilled in the art will understand that these orientations may vary during actual use of the invention and are not intended to be limiting.

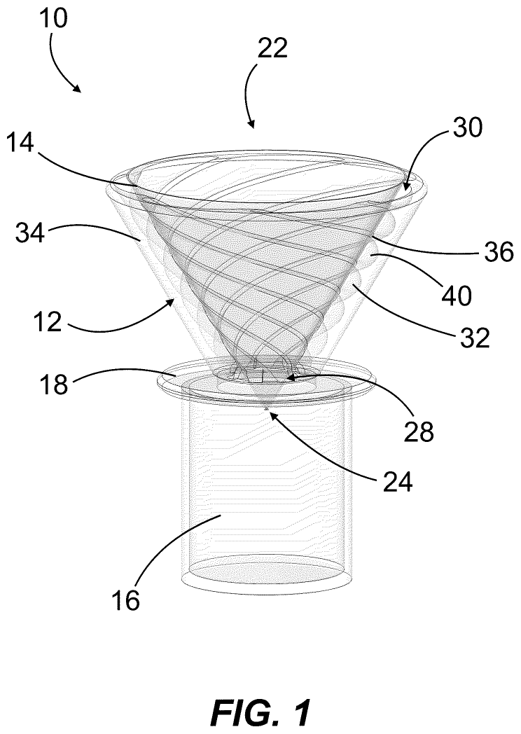

FIG. 1 is a perspective view of an embodiment of a heat retention coffee dripper, filter, base, and beverage container. The heat retention coffee dripper 10 comprises a dripper body 12, a filter 14 positioned inside the dripper body, and a base 18 coupled to the dripper body. The base 18 holds the dripper body 12 on top of a beverage container 16.

The dripper body 12 has a fluid pathway, which is the route the fluid takes from the fluid entrance 22 to the fluid exit 24. The fluid entrance 22, located at the top of the dripper body 12 and filter 14, accepts hot water poured over a coffee bed in the filter 14. The filter 14 functions as an infusing chamber, allowing the brewing process to take place by holding the coffee grounds and enabling water to pass through, extracting flavors and aromas. The brewed beverage then exits the fluid exit 24 at the bottom of the filter 14 and dripper body 12 into the beverage container 16. The path between the fluid entrance 22 and the fluid exit 24 is the fluid pathway.

The dripper body 12 also includes a vent pathway 26, consisting of a vent entrance 28, located near the bottom of the dripper body 12, and a vent exit 30, located above the vent entrance 28. The vent entrance 28 accepts heat, steam, aroma, and energy from the brewed beverage. It can be a hole or passage. The vent exit 30 is where the vented elements are released, located above the vent entrance 28, and can also be a hole or passage. The vent pathway 26 is the route through which steam, aroma, and heat are vented from the vent entrance 28 to the vent exit 30. This pathway can be primary or secondary, substantially non-linear or not substantially linear, and may include variable control or a valve to manage airflow. The vent pathway can vary in shape, volume, strategy, efficiency, multitude, and complexity.

Flow directing structures 32 form the passages for the vent pathway, determining its path and time spent inside the system before leaving the vent exit 30. These structures are designed to manipulate the flow of venting air, steam, heat, and aroma, optimizing heat retention and improving the brewing process. Examples of flow directing structures 32 include, but are not limited to, the following, either on their own or in combination with each other: baffle chambers, helical channels, serpentine channels, guide vane channels, static mixers, diffusers, and nozzles.

In this embodiment, the flow directing structures 32 form seven helical channels 40, which are a series of spiraling grooves extending from the bottom to the top of the dripper body 12. These channels deliver heat from the beverage container 16 back up into the dripper body 12 and filter 14, heating the brew while maintaining acceptable flow rate. These channels form the vent pathway 26, efficiently heating the brewing beverage by extending the vent pathway in a conical upward spiral, while maintaining a good flow rate. The interior surface of the wall 34 of the dripper body 12 features these helical channels 40.

Additionally, the filter support geometry 36 supports the filter 14, helping it maintain its shape. In this embodiment, the filter support geometry 36 is a plurality of spiraling ridges extending from the flow directing structures 32. This configuration ensures the stability of the filter 14 and the efficient operation of the fluid and vent pathways.

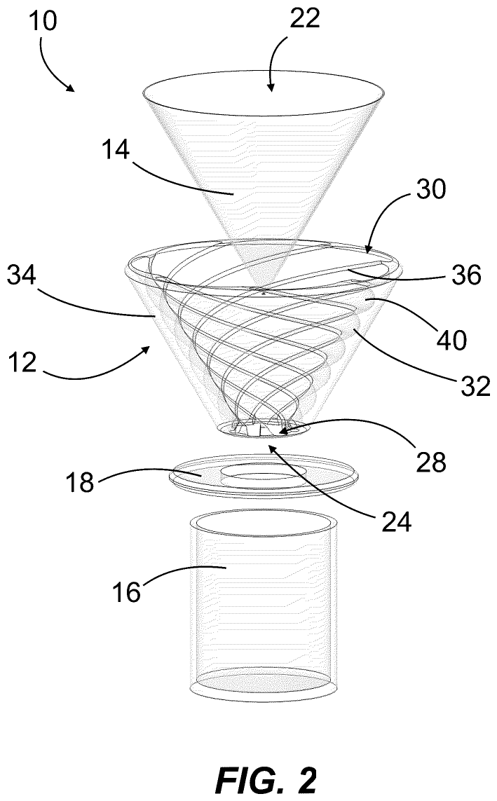

FIG. 2 is an exploded perspective view of the embodiment shown in FIG. 1, depicting a heat retention coffee dripper, filter, base, and beverage container. This view illustrates the relationship between the filter 14, dripper body 12, base 18, and beverage container 16.

In this embodiment, the filter 14 and dripper body 12 are separate components made of different materials. However, an embodiment exists where they are made from the same material or formed as a single unit. For example, an all-metal construction where a series of small holes make up the fluid exit 24 and function as a filter for the brewing beverage.

Additionally, the base 18 and dripper body 12 are two distinct components. They may also be made as one unibody or remain as two separate components, potentially using the same or different materials. These materials can include metal, plastic, ceramic, etc. In this embodiment, they are both constructed of a clear BPA free plastic.

The filter 14 in this embodiment is a paper cone shape, but it could also be made from various materials such as paper, cloth, or metal. The shape of the filter can vary and includes cone-shaped, flat-bottomed, smooth or ridged sides, and other configurations. These variations in shape, size, and material do not escape the scope of the claims.

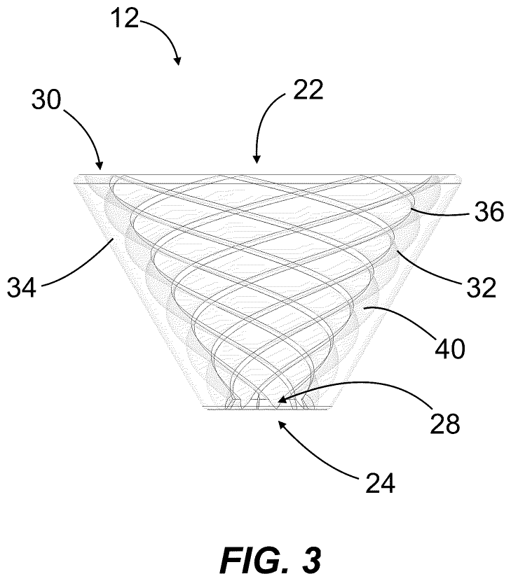

FIG. 3 is a front elevation view of an embodiment of a heat retention coffee dripper 10 dripper body 12 without a filter, base, or beverage container.

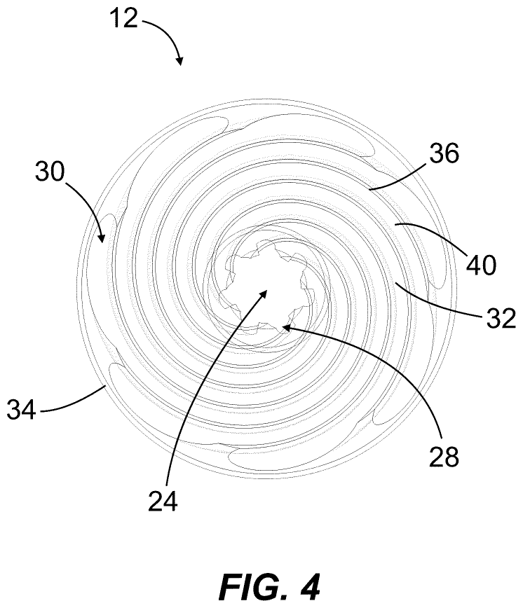

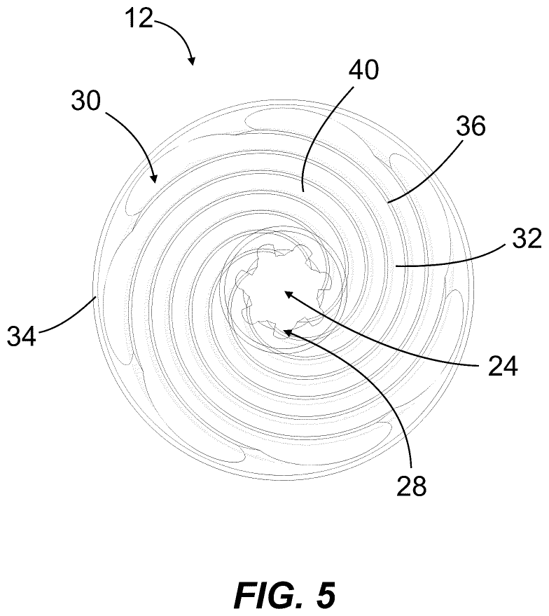

FIG. 4 and FIG. 5 are top and bottom plan views, respectively, of an embodiment of a heat retention coffee dripper 10 dripper body 12 without a filter, base, or beverage container. In these views, one can clearly see the seven spiraling vent pathways 26 from the vent entrance 28 to the vent exit 30, created by the flow directing structures 32, in this case, seven helical channels 40.

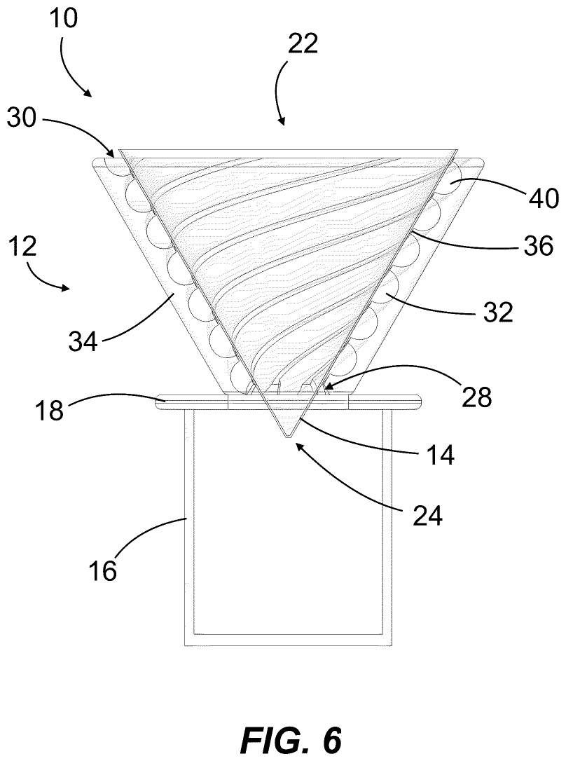

FIG. 6 is a front cross-sectional view of an embodiment of a heat retention coffee dripper 10 dripper body 12, filter 14, base 18, and beverage container 16. This illustrates how the filter 14 is adjacent to the interior opening in the vent passage in this embodiment, allowing the heat moving through the vent passage to directly heat the filter and its contents as it flows from the vent entrance 28 to the vent exit 30.

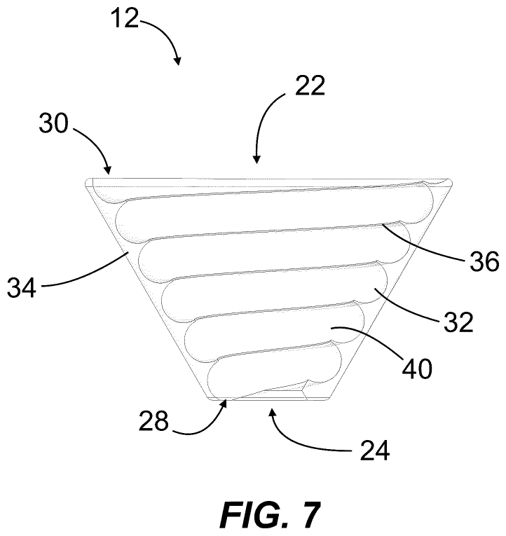

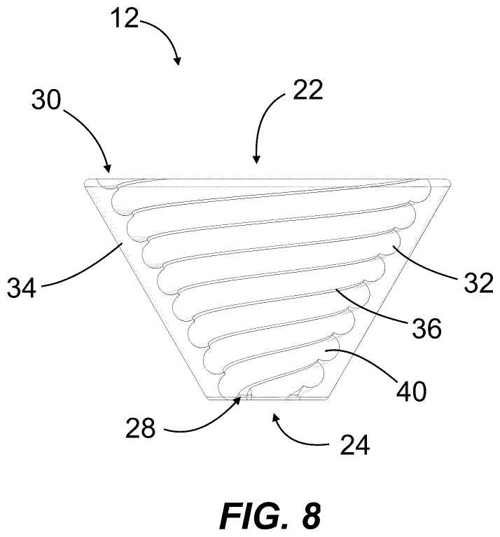

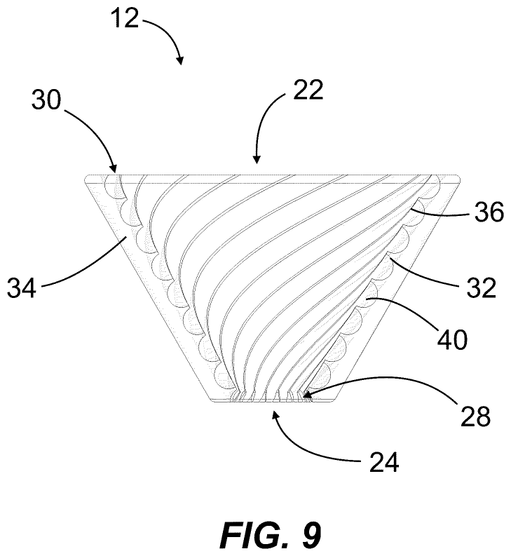

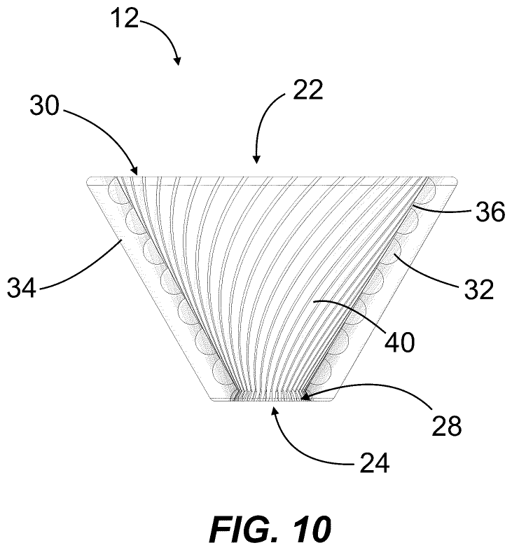

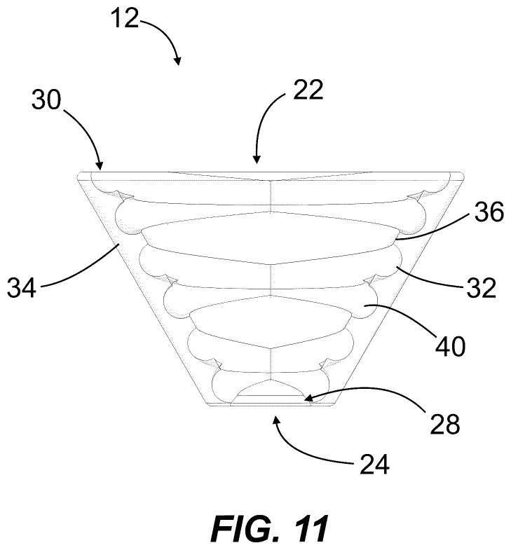

FIGS. 7 through 10 include variations of embodiments whose flow directing structures 32 form helical channels 40 as their vent pathway 26. These embodiments range from one helical channel to forty, varying in size, rotational pitch, and number of rotations around the dripper body ranging from less than one rotation to more than one rotation. FIG. 11 includes an embodiment of a dripper body 12 where the flow directing structures 32 create a double helix crossing pattern. These embodiments serve to show the variety of vent pathways 26, or flow directing structures 32, that may be made without escaping the scope of the claims. All of these embodiments increase heat exposure to the system while maintaining a good flow rate.

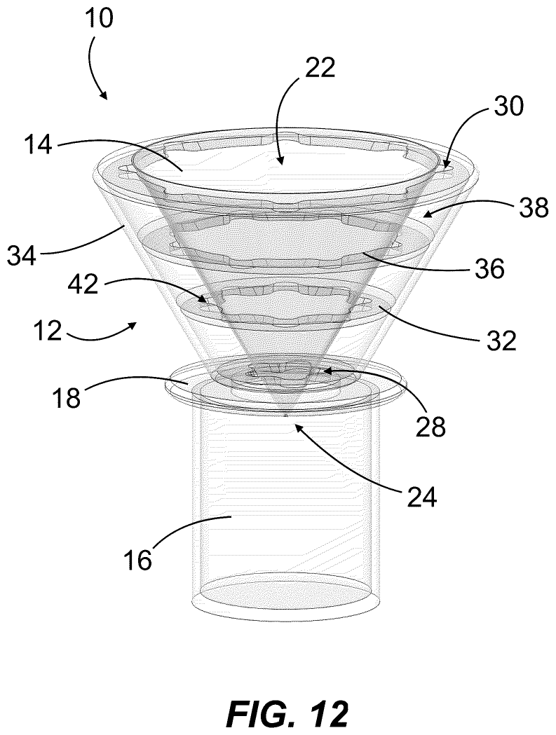

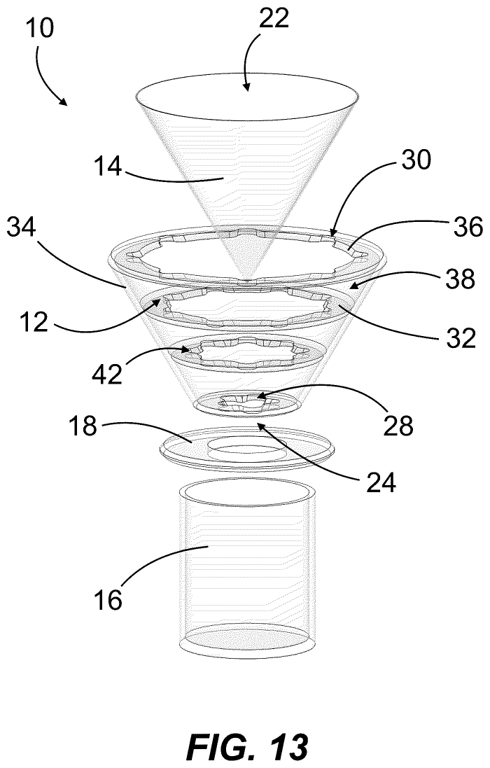

FIG. 12 and FIG. 13 are perspective views and exploded perspective views, respectively, of embodiments of a heat retention coffee dripper 10, dripper body 12, filter 14, base 18, and beverage container 16. This dripper body functions similarly to the embodiment from FIG. 1 but instead, the flow directing structures 32 form baffle chambers 38 with strategically placed baffle passages 42. Like the helical channel, the baffled chamber traps heat in the system longer while also providing a sufficient flow rate. While this embodiment shows three chambers that make up the vent pathway 26 from the vent entrance 28 to the vent exit 30, a single chamber or multiple chambers of different sizes, shapes, or volumes can be implemented without departing from the scope of the claims.

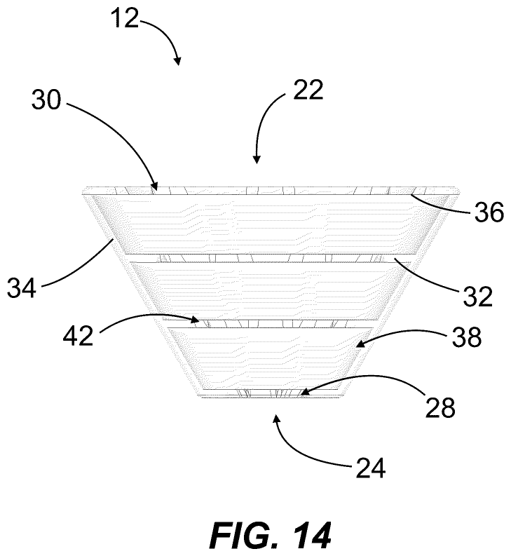

FIG. 14 is a front elevation view of an embodiment of a heat retention coffee dripper 10 dripper body 12 without a filter, base, or beverage container.

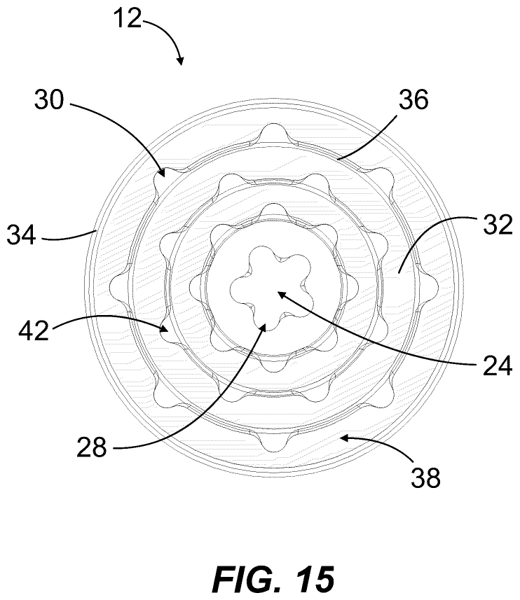

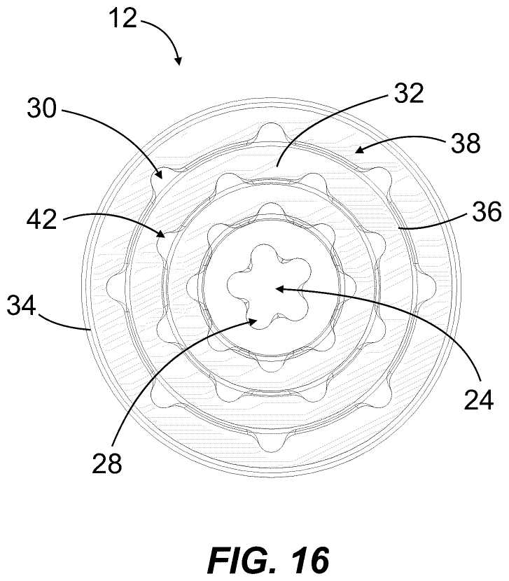

FIG. 15 and FIG. 16 are top and bottom plan views, respectively, of an embodiment of a heat retention coffee dripper 10 dripper body 12 without a filter, base, or beverage container. In these views, one can clearly see the vent pathways 26 from the vent entrance 28 to the vent exit 30, created by the flow directing structures 32, in this case, three baffle chambers 38 and baffle passages 42.

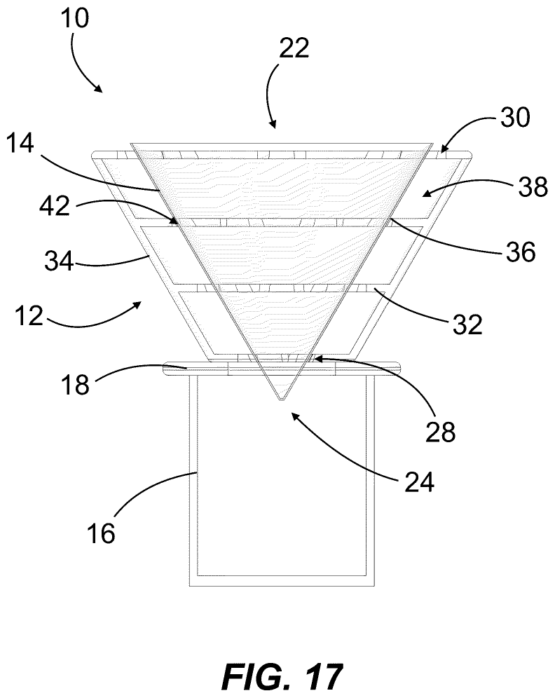

FIG. 17 is a front cross-sectional view of an embodiment of a heat retention coffee dripper 10 dripper body 12, filter 14, base 18, and beverage container 16. This illustrates how the filter 14 is adjacent to the opening in the vent passage in this embodiment, allowing the heat moving through the vent passage to directly heat the filter and its contents as it flows from the vent entrance 28 to the vent exit 30. The filter 14 forms an inner wall to the baffle chamber 38, enhancing heat transfer efficiency within the system.

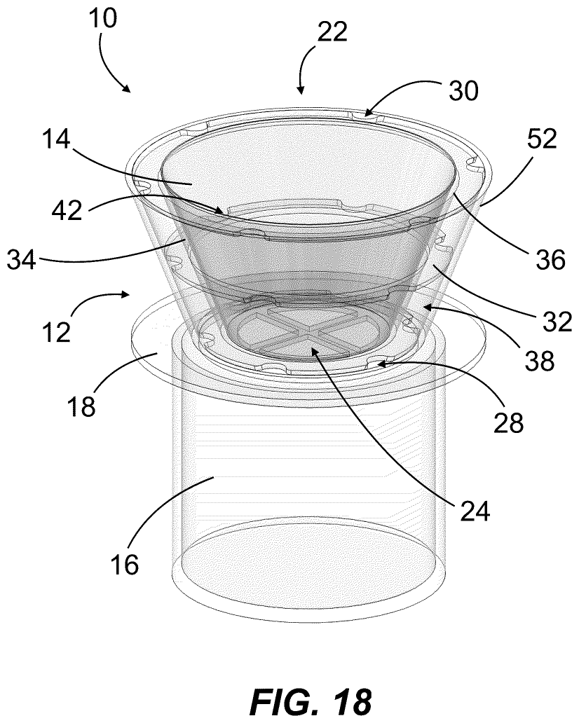

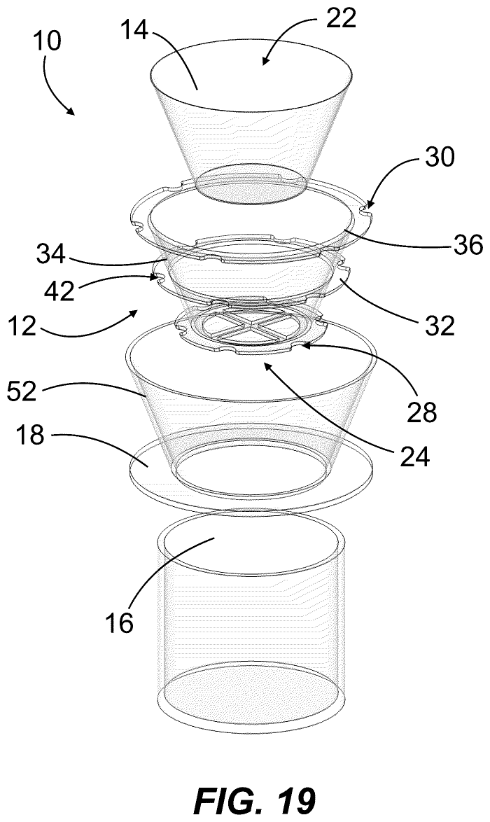

FIG. 18 and FIG. 19 are perspective views and exploded perspective views, respectively, of embodiments of a heat retention coffee dripper 10, filter body 12, filter 14, base 18, and beverage container 16. This dripper body 12 functions similarly to the embodiments disclosed prior but instead, the flow directing structures 32, which form baffle chambers 38 and baffle passages 42, are located on the exterior of the dripper wall 34. In this embodiment, the base 18 is coupled to an outer wall 52 that helps form the baffle chamber, allowing a vent pathway to transfer the rising heat to the dripper wall, thereby heating the adjacent filter 14 and its contents. This design maintains heat efficiency and flow rate while keeping condensation from steam away from the filter.

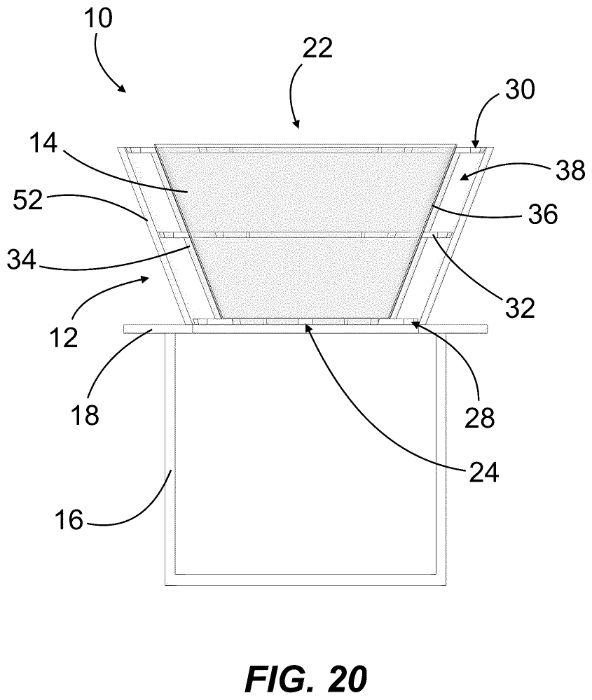

FIG. 20 is a front cross-sectional view of an embodiment of a heat retention coffee dripper 10 dripper body 12, filter 14, base 18, and beverage container 16. This illustrates how the filter 14 is adjacent to the dripper wall 34, allowing the heat moving through the vent passage to directly heat the dripper wall, filter, and its contents as it flows from the vent entrance 28 to the vent exit 30.

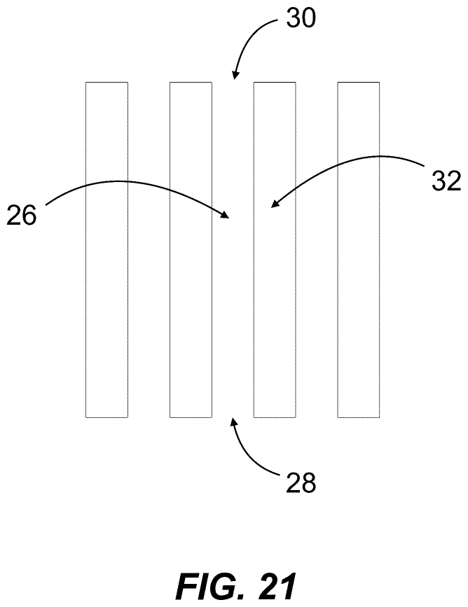

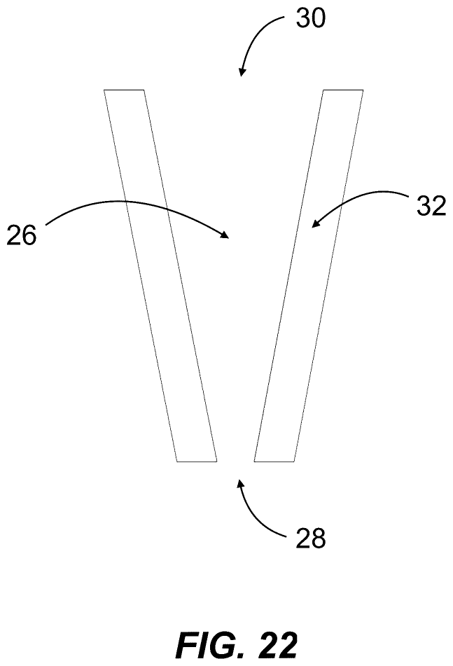

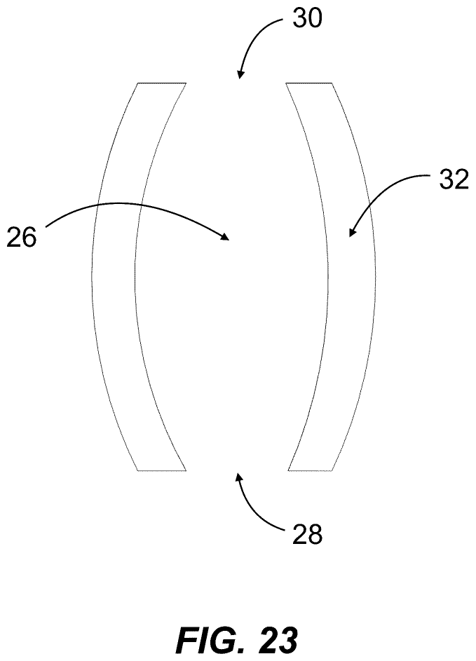

FIGS. 21 through 23 are schematic views of simplified flow directing structures. These schematics represent linear and significantly linear vent pathways formed by flow directing structures. These pathways efficiently guide the venting air, steam, heat, and aroma from the vent entrance 28 to the vent exit 30, providing straightforward channels that optimize the flow rate but do not maintaining adequate heat retention.

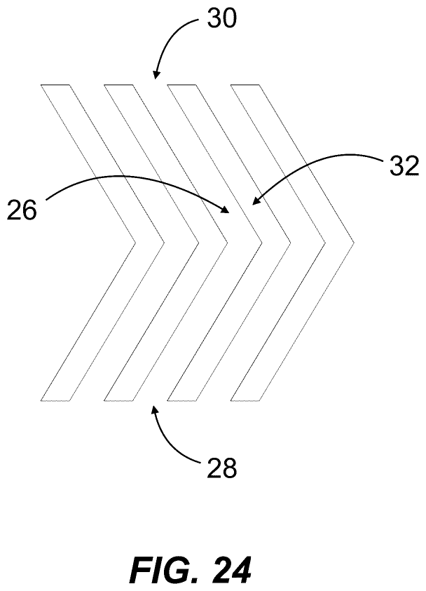

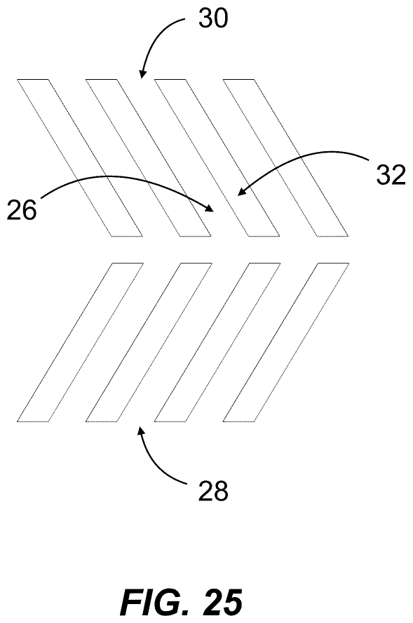

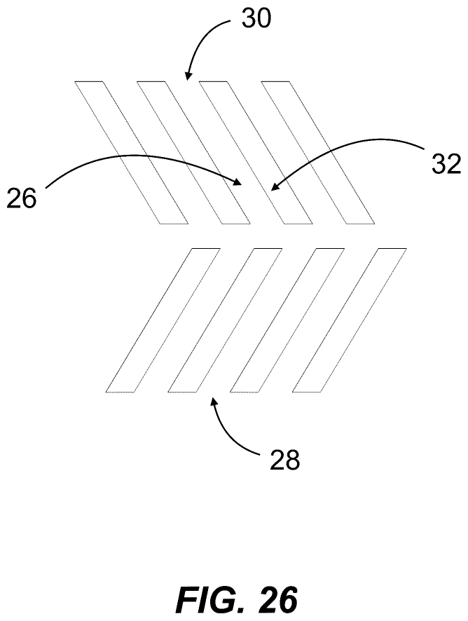

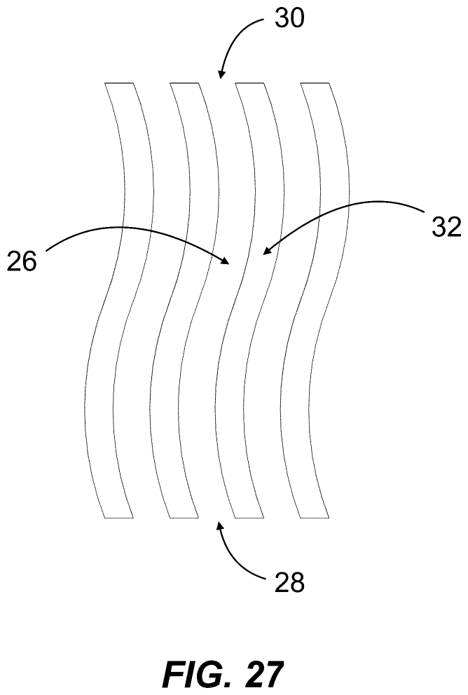

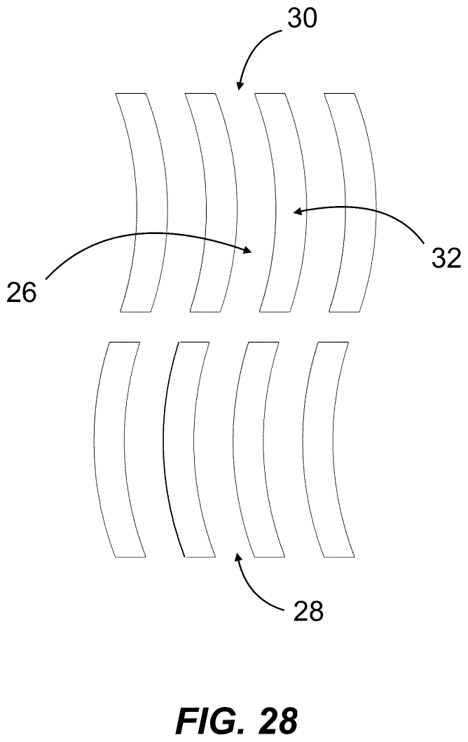

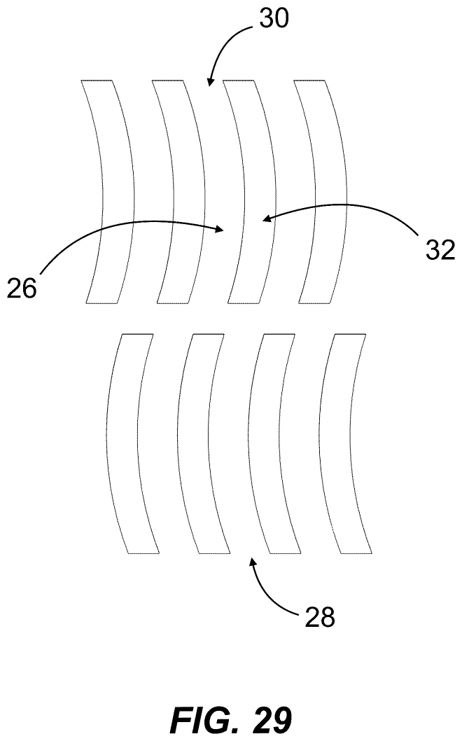

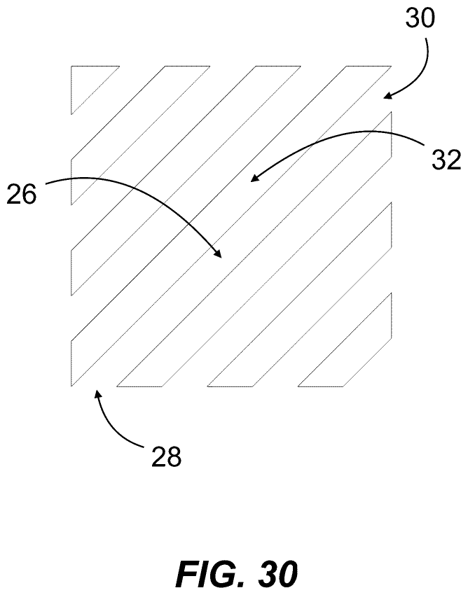

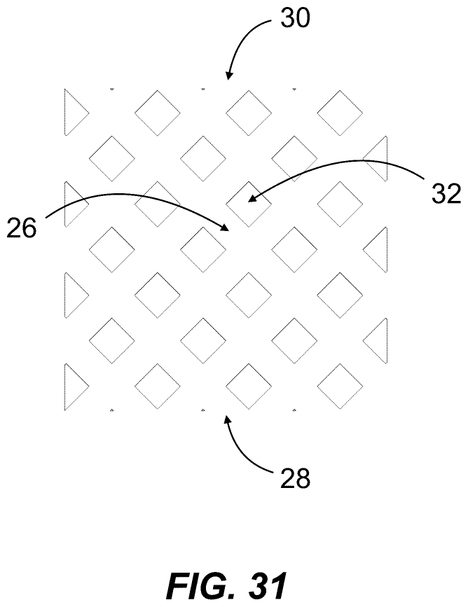

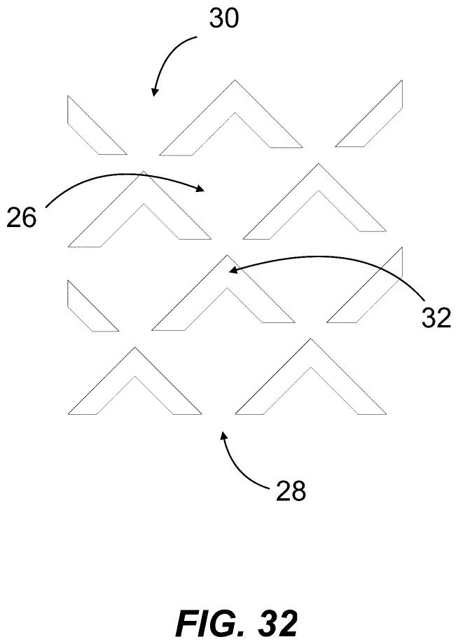

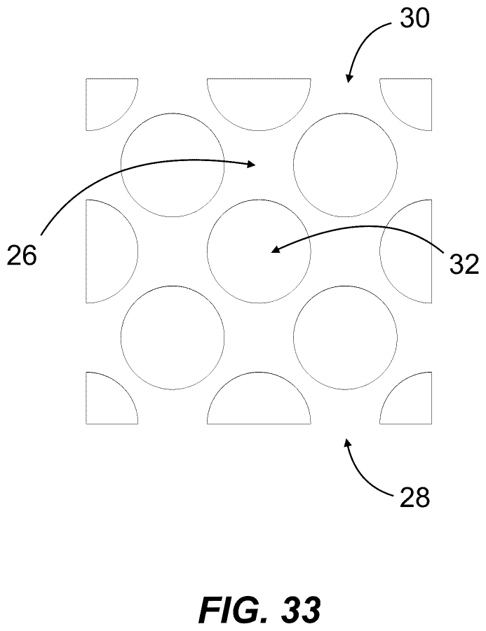

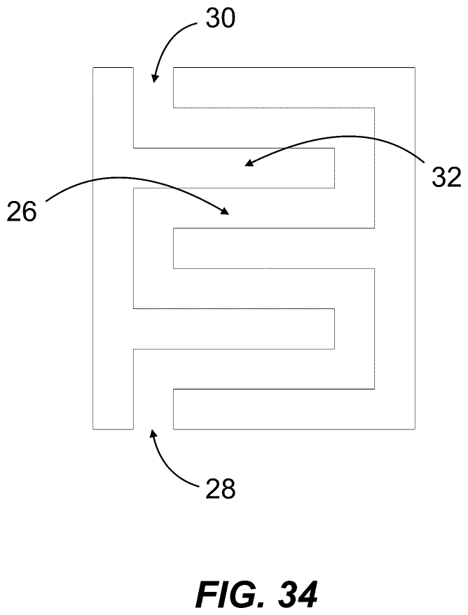

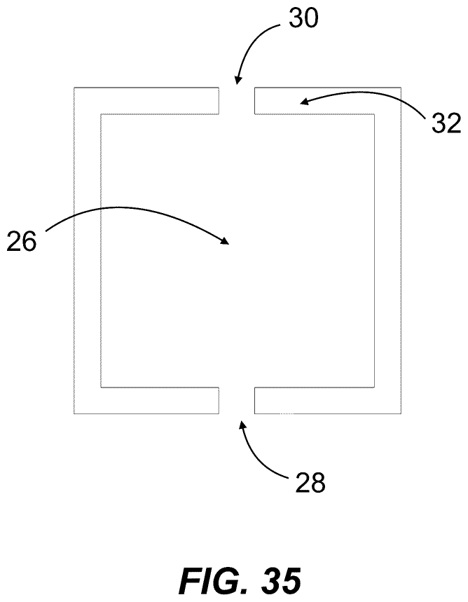

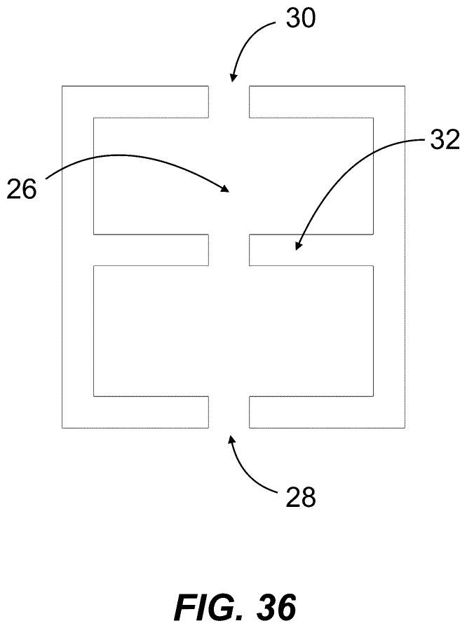

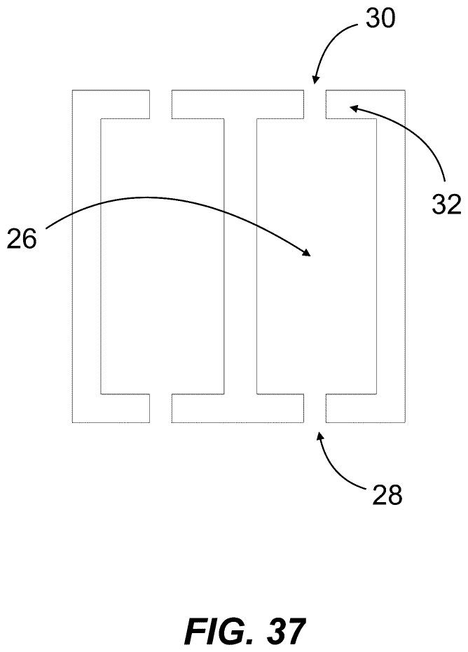

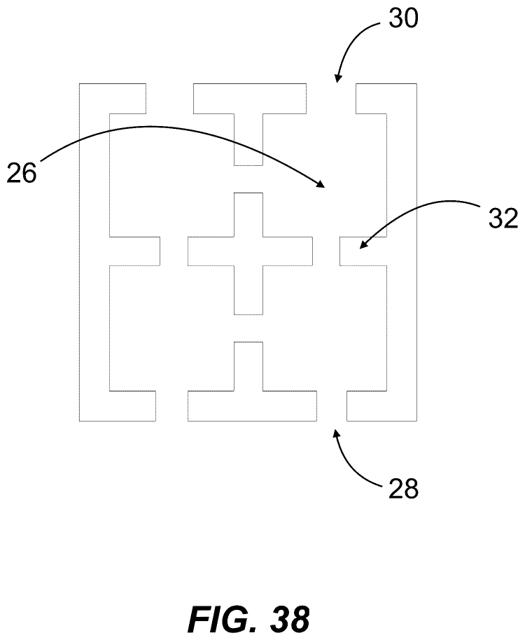

FIGS. 24 through 38 are schematic views of more complex flow directing structures. These schematics represent non-linear and significantly non-linear vent pathways formed by various flow directing structures. These pathways include configurations such as helical channels, serpentine routes, and baffle chambers, which increase the duration of heat exposure within the system. This extended pathway enhances heat retention by ensuring the venting air, steam, heat, and aroma interact more extensively with the dripper body and filter, thereby optimizing the brewing temperature and maintaining flow rate.

Flow directing structures 32 are essential elements within the vent pathway 26 of the coffee dripper, designed to manipulate the flow of venting air, steam, heat, and aroma. These structures optimize heat retention and improve the brewing process by controlling airflow with various designs.

Examples of flow directing structures that can be implemented in embodiments include, but are not limited to, the following, either on their own or in combination with each other: A baffle chamber contains one or multiple baffles to create turbulence and extend the venting air's path, enhancing heat retention. The chamber can be a single unit, a stack of baffles, or a sub-chamber with strategically placed holes or passages. Helical channels provide a spiraling pathway for air, which can be single or multiple, crossing or non-crossing, and shaped in various forms such as square, circular, or triangular. These channels extend the air's travel path to increase the duration of heat exposure. Serpentine channels, characterized by multiple curves or bends, also extend the air's travel path. By slowing down the airflow, these channels enhance heat retention within the system. Guide vane channels use diverging vanes to split and control the direction of airflow, ensuring even distribution and prolonged exposure to heat. Static mixers, with their series of deflectors or angled fins, mix and direct airflow without moving parts, thereby increasing heat transfer efficiency. Diffusers, structural elements with holes or passages, spread airflow evenly, reducing its velocity and ensuring uniform distribution to improve heat retention. Nozzles, which direct airflow in a specific direction through a hole or passage, focus and control the air's exit path, extending the duration of heat exposure within the vent pathway. These flow directing structures are integral to the function of the heat retention coffee dripper, ensuring that the vent pathway effectively manages and retains heat while maintaining proper flow rate, thereby enhancing the brewing process and resulting in a better quality cup of coffee.

What is claimed is:

1. A heat retention coffee dripper, comprising:
a dripper body and a filter,
Wherein, said dripper body is designed to sit on a beverage container,
Said dripper body having at least one fluid pathway and at least one vent pathway,
Wherein said vent pathway includes at least one flow directing structure configured to extend the vent pathway to increase heat retention.

2. The heat retention coffee dripper of claim 1, wherein the flow directing structure comprises at least one baffle chamber vent pathway.

3. The heat retention coffee dripper of claim 1, wherein the flow directing structure comprises at least one helical vent pathway.

4. The heat retention coffee dripper of claim 1, wherein the flow directing structure comprises at least one serpentine vent pathway.

5. The heat retention coffee dripper of claim 1, wherein the flow directing structure comprises at least one guide vane vent pathway.

6. The heat retention coffee dripper of claim 1, wherein the flow directing structure comprises at least one static mixer vent pathway.

7. The heat retention coffee dripper of claim 1, wherein the flow directing structure comprises at least one diffuser vent pathway.

8. The heat retention coffee dripper of claim 1, wherein the flow directing structure comprises at least one nozzle vent pathway.

9. The heat retention coffee dripper of claim 1, wherein the flow directing structures are located on the exterior of the dripper wall.

10. The heat retention coffee dripper of claim 1, wherein the flow directing structures are located on the interior of the dripper wall.

11. The heat retention coffee dripper of claim 1, wherein the dripper body couples to a base.

12. The heat retention coffee dripper of claim 1, wherein the fluid exit comprises many small holes that act as a filter.

13. The heat retention coffee dripper of claim 1, wherein the filter is paper.

14. The heat retention coffee dripper of claim 1, wherein the filter is cloth.

15. The heat retention coffee dripper of claim 1, wherein the filter is metal.

16. The heat retention coffee dripper of claim 1, wherein the dripper body is plastic.

17. The heat retention coffee dripper of claim 1, wherein the dripper body is metal.

18. The heat retention coffee dripper of claim 1, wherein the dripper body is ceramic.

19. The heat retention coffee dripper of claim 1, wherein the dripper body and the base are unibody construction.

20. The heat retention coffee dripper of claim 1, wherein the dripper body and the directing structures are separate bodies that are assembled.
